(19) United States
(12) Patent Application Publication
(10) Pub. No.: US 2016/0171140 A1
(43) Pub. Date: Jun. 16, 2016

(54) METHOD AND SYSTEM FOR DETERMINING MINIMUM OPERATIONAL VOLTAGE FOR TRANSISTOR MEMORY-BASED DEVICES

(71) Applicant: FREESCALE SEMICONDUCTOR, INC., AUSTIN, TX (US)

(72) Inventors: SANJAY R. PARIHAR, AUSTIN, TX (US); MEHUL D. SHROFF, AUSTIN, TX (US)

(21) Appl. No.: 14/567,634

(22) Filed: Dec. 11, 2014

(51) Int. Cl. G06F 17/50

(52) U.S. Cl. CPC G06F 17/5045; G06F 17/5009

(57) ABSTRACT

A mechanism is provided by which a failure analysis during design of one or more memory arrays used in a system on a chip can take into account an operational voltage use profile over the projected life of the chip. The failure analysis is then used in chip redesign decision-making or modification of the use profile. As a result, memory arrays used in chip design can be more closely matched to the actual use of the chip, rather than being overly-conservatively designed, thereby resulting in physically smaller or more efficient memory arrays and thus smaller chips.

### BACKGROUND

1. Field

This disclosure relates generally to design of semiconductor devices, and more specifically, to estimating minimum operational voltages for semiconductor devices incorporating memory bitcells and transistors that operate at more than one voltage over their life cycle.

2. Related Art

Semiconductor devices, such as integrated circuits and printed circuit boards, perform a variety of functions to process data and interface with external components. These devices are often expected to perform functions in a variety of operational environments, operational voltages, and conditions over a prolonged period of time. For example, automotive engine controllers include semiconductor devices that need to operate in extremes of heat and cold over the lifetime of the automobile. As another example, certain processors are intended to function at two or more operational voltages for reasons such as to improve processing time (i.e., higher voltages) or to save power (i.e., lower voltages). As certain semiconductor devices age, they can experience shifts in their operational parameters due to the environment and usage of the device.

One ageing effect in certain transistors is bias temperature instability (BTI) that can result in charge carriers becoming trapped in the gate dielectric of the transistor when a high gate-to-source voltage is applied to the device. As the number of charge carriers trapped in the dielectric layer increases, the minimum operating threshold voltage (Vₘᵢₙ) of the transistor rises, and slows down the transistor over time, resulting in rising circuit performance failures. BTI for both n-type and p-type transistors is sensitive to temperature and voltage, and therefore can present different ageing characteristics in differing operational conditions. Further, BTI ageing of n-type and p-type transistors does not proceed equally, and therefore can throw bitcells incorporating both out of balance. Other types of ageing effects can occur over the lifetime of a transistor, including, for example, hot carrier injection (HCI).

FIG. 1 is a chart illustrating a failure probability of a bit in a memory array versus the supplied DC voltage to the transistors in the memory array (V_{dd}). Curve 110 on the chart illustrates failure probability as a function of V_{dd} at an initial time (t₀). As can be seen, for low V_{dd}, the failure probability is high and, as V_{dd} increases, the failure probability drops. Over time, however, as various ageing mechanisms affect the transistors in the memory array, there is a shift upward in the failure probability curve, as illustrated by curve 120. This curve suggests that as a memory array ages, the likelihood of a failure rises for any particular V_{dd}. Alternatively, in order to maintain a particular likelihood of failure, the V_{dd} will rise over time.

Traditional methods for determining ageing effects during design typically consider worst-case scenarios. For example, for devices that are intended to operate at two or more voltages (e.g., V_{dd} for memory cells), the highest operational voltage is used for ageing calculations. This can result in an overly conservative determination of ageing (e.g., curve 120), and therefore higher than necessary minimum operational voltages over time. As another example, for devices that operate in different environmental temperatures, the highest temperature may be used for ageing calculations, which again results in an overly conservative ageing determination. It is therefore desirable to provide a mechanism for determining ageing effects during device design that can take into account variable operational characteristics so as to avoid overly conservative estimates of ageing effects on minimum operational voltages.

### BRIEF DESCRIPTION OF THE DRAWINGS

The present invention may be better understood, and its numerous objects, features, and advantages made apparent to those skilled in the art by referencing the accompanying drawings.

FIG. 1 is a chart illustrating a failure probability of a bit in a memory array versus the supplied operational voltage to the transistors in the memory array (V_{dd}).

FIG. 2 is a simplified block diagram illustrating an example of a set of semiconductor device design systems configured to perform design and verification tasks.

FIG. 3 is a chart illustrating a shift in a minimum operational voltage (Vₘᵢₙ) of a semiconductor device in light of differing use profiles and differing high V_{dd} over the life of the part.

FIG. 4 is a simplified block diagram illustrating a system for generating a failure probability for bit ageing over the lifetime of a chip that takes into account an operational use profile, in accord with embodiments of the present invention.

FIG. 5 is a simplified flow diagram illustrating a process for providing a read/write failure analysis as executed by a read/write failure analysis module.

FIG. 6 is a simplified block diagram illustrating BTI in a MOSFET having p-type source and drain regions.

FIG. 7 is a simplified block diagram illustrating hot-carrier injection (HCI) in a MOSFET having n-type source and drain regions.

The use of the same reference symbols in different drawings indicates identical items unless otherwise noted. The figures are not necessarily drawn to scale.

### DETAILED DESCRIPTION

Embodiments of the present invention provide a mechanism by which a failure analysis during design of one or more memory arrays used in a system on a chip can take into account an operational voltage use profile over the projected life of the chip. The failure analysis is then used in chip redesign decision-making or modification of the use profile. As a result, memory arrays used in chip design can be more closely matched to the actual use of the chip, rather than being overly-conservatively designed, thereby resulting in physically smaller or more efficient memory arrays and thus smaller chips.

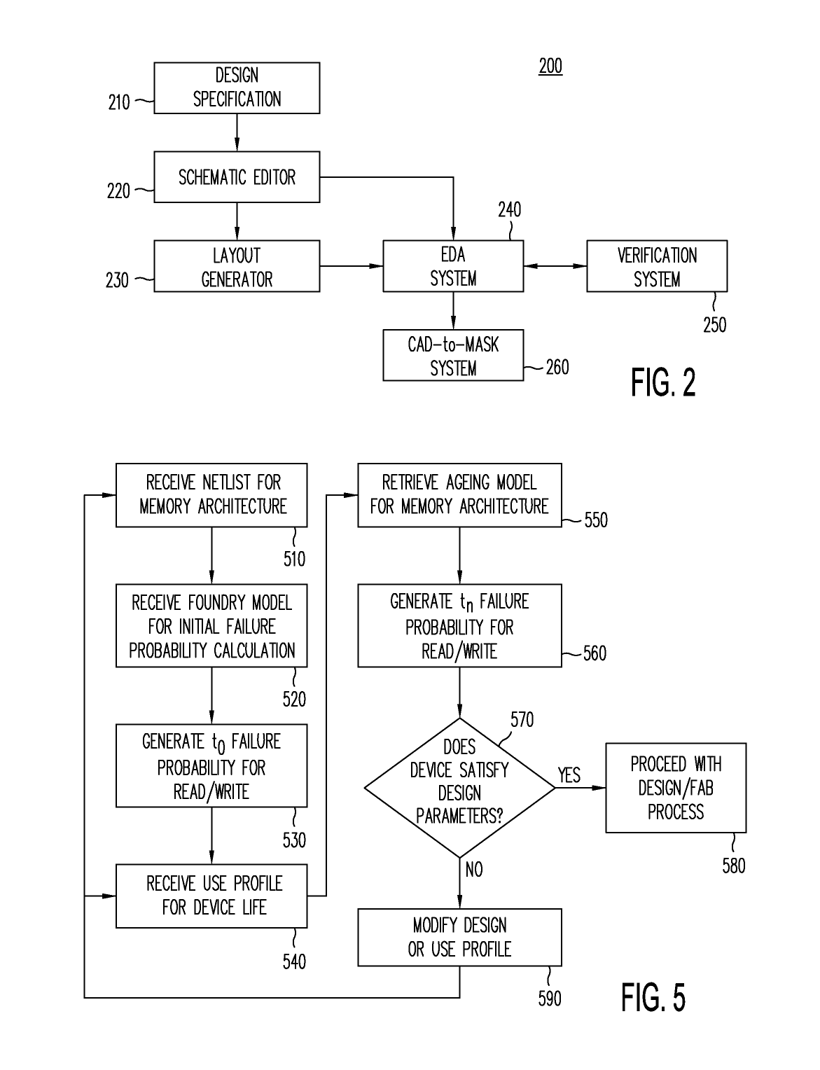

FIG. 2 is a simplified block diagram illustrating an example of a set of semiconductor device design systems 200 configured to perform design and verification tasks, and incorporating embodiments of the present invention.

An initial step in the process of a semiconductor device design is generation of a schematic. A schematic provides a graphical representation of the desired semiconductor device. Schematic generation is informed by a provided design specification. The design specification describes the various tasks, environments, and capabilities expected of the semiconductor device. In some embodiments, schematic generation can be performed using a schematic editor 220 that is a part of a design environment 200. Design environment 200 can include one or more processors or processing systems configured to provide specific functionality and coupled to or providing interface devices that enable the provision of that functionality. For example, the schematic editor can include specialized tablet input devices for input of the schematic elements as well as a specialized display to illustrate the elements and their connections. Further, the schematic editor can include libraries of schematic elements and combinations of elements available for the semiconductor device.

The schematic can then be used in the process of generating a computer-aided design (CAD) layout of the semiconductor device. One or more modules comprising a layout generator 230 can be used to perform the generation of the semiconductor device layout by a layout engineer. Generation of the layout can include combinations of standard cells representing the various elements or combinations of elements of the semiconductor device. These standard cells can include specifications for the represented elements, such as height, width, timing, power, and the like. An electronic design automation (EDA) toolset 240 can also be used in the construction of the CAD layout. These EDA tools can be used to simulate the performance of the combined elements in the device design. In addition, the EDA tools can access a verification system 250 that ensures design rules, such as spacing and the like, are adhered to for a chosen process through, for example, a design rule check (DRC) module, and the layout and schematic connectivity and attributes are in agreement through a layout versus schematic (LVS) module. Once the device CAD layout has been verified during the design stage, a file can be generated that includes a description of the device CAD layout (e.g., a GDS file), which is then provided to the mask generation stage of the flow.

The device IC masks are generated by using, for example, a CAD-to-Mask system 260. As discussed above, in addition to generation of physical mask layers representing the CAD layout (e.g., the CAD layers), physical mask generation also includes computed layers provided by, for example, Boolean mask operations. These computed layers, such as P-well, NMOS Lightly Doped Drain (NLDD), and the like, can be generated using the information from the CAD layers, as well as information regarding the specific process technology being used to make the physical device. In addition, CAD-to-Mask system 260 can also use optical proximity correction (OPC) to modify the mask shapes in order to compensate for optical effects associated with a particular process technology. A post-CAD-to-Mask design rule check module can perform a series of rules checks to ensure that the generated masks are within the physical parameters of the process technology. If there is a violation of those rules, this information can be fed back to the CAD-to-Mask system and appropriate corrections can be made. The masks can then be used in the fabrication process of the semiconductor device.

Embodiments of the present invention can be present in the design flow executed by the semiconductor device design system represented by FIG. 2. As an example, the verification process executed by verification system 250 or EDA system 240 can incorporate the process described below, and use the results of that process to determine whether a modification to the schematic, layout or use profile of the semiconductor device is indicated, prior to generation of mask sets for the semiconductor device.

Embodiments of the present invention provide a mechanism to analyze semiconductor devices that are placed in operational environments in which those devices are expected to function for many years. Over that period of time, semiconductor devices such as transistors can experience ageing effects due to normal operational conditions. In addition, those operational environments can expose the devices to extremes of heat and cold, for example, which can accelerate ageing damage to the semiconductor devices.

One ageing effect in certain metal oxide semiconductor field effect transistors (MOSFETs) is bias temperature instability (BTI), which becomes a factor at high gate-to-source voltages (V_{GS}). A high V_{GS} creates a high vertical electric field across the gate channel that leads to charge carriers (i.e., electrons or holes) from the transistor channel being pulled into the gate dielectric, which then traps the charge carriers. In high dielectric constant metal gates, such as those found in the small area devices present in modern systems on chips, the damage can be proportional to the length and width of the channel. As the number of trapped charge carriers increases, the minimum operating threshold voltage (Vₘᵢₙ) of the transistor rises, and makes it more difficult to use the transistor. BTI is more common during static operation of a transistor than in switching operation.

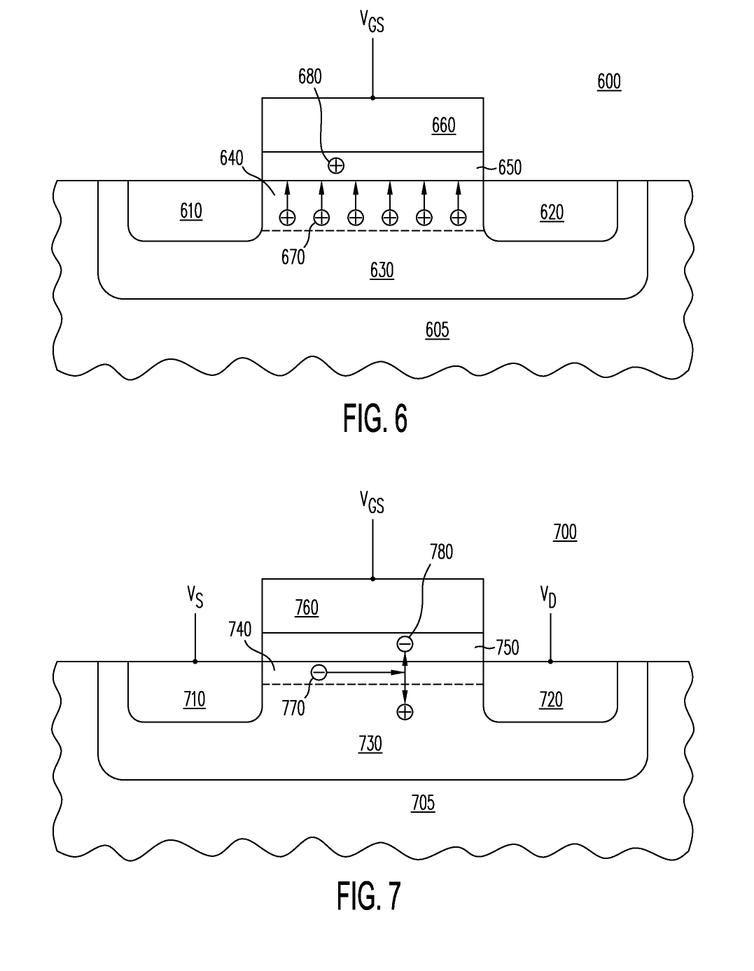

FIG. 6 is a simplified block diagram illustrating BTI in a MOSFET 600 having p-type source and drain regions, 610 and 620, respectively. An n-doped region (n-well 630) is beneath the source and drain regions, and a portion of the n-well forms channel region 640. The source, drain, and n-well regions are formed using standard semiconductor fabrication techniques. Above the channel region is formed a gate dielectric layer 650 and a metal gate layer 660. Again, the gate dielectric layer and metal gate layer are formed using deposition techniques known in the art of semiconductor manufacture.

V_{GS} refers to a voltage difference between metal gate layer 660 and source region 610, which can equal the V_{dd}. As V_{GS} increases, the number of charge carriers 670 near the gate dielectric/channel layer interface of the channel layer 640 increases. At sufficiently high V_{GS}, one or more of the charge carriers are drawn into gate dielectric layer 650 and trapped (e.g., trapped charge carrier 680). One example of the source of these charge carriers is a weakening and breaking of silicon-hydrogen bonds at the interface between the silicon of the channel region and the gate dielectric layer under the influence of the high V_{GS}.

While BTI ageing is dependent upon temperature, V_{GS}, and length of the transistor channel, those dependencies are different for NMOS and PMOS. Hence, the same supply voltage and temperature use profile will result in different amounts of NBTI (for the PMOS) vs. PBTI (for the NMOS) damage. For example, an BTI damage and Vₘᵢₙ shift due to BTI can be represented by the following equations:

D_{BTI}=K*Time*a(T)*f(V_{GS},V_{Ds})*g(device)

Vₘᵢₙshift=D_{BTI}^{1/n}
where K=fitting constant
   a(T)=temperature function
   f(Vgs)=voltage function (power law or exponential)
   g(device)=function of device parameters (e.g., width, length, initial Vₜ)
      The formulas in the damages equations for NBTI and PBTI are typically not the same. Thus, not only is the damage due to BTI equations different dependent upon the temperature, device parameters, and voltage, but also even if the damage were similar between the PMOS and NMOS transistors, the Vₘᵢₙ shift would be different due to a different voltage dependence. This difference in ageing of PMOS and NMOS transistors will throw off the designed balance between the NMOS and PMOS transistors in a memory cell. The balance between PMOS and NMOS in a bitcell can be determinative of whether the memory is limited by write or read operations

Another ageing effect that can be experienced by MOSFETs is hot carrier injection (HCI), which can occur when the V_{GS} is greater than the threshold voltage (Vₘᵢₙ) in conjunction with a moderate to high source-to-drain voltage (V_{DS}) magnitude. The high electric field in the channel causes impact ionization of current carriers, some of which can become embedded in the gate dielectric. HCI damage is inversely proportional to channel length, and is more prevalent during switching than static operation.

FIG. 7 is a simplified block diagram illustrating HCI in a MOSFET 700 having n-type source and drain regions, 710 and 720, respectively. A p-type region (p-well 730) is beneath the source and drain regions, and a portion of the p-well forms channel region 740. Above the channel region is formed a gate dielectric layer 750 and a metal gate layer 760. The source, drain, p-well, gate dielectric layer, and metal gate layer are formed using techniques known in the art of semiconductor manufacture. As illustrated, during HCI, charge carriers in the channel (e.g., electron 770) provide a sufficient current that if a charge carrier impacts another charge carrier, impact ionization can result in a charge carrier being knocked into the gate dielectric layer and becoming trapped there (e.g., trapped electron 780).

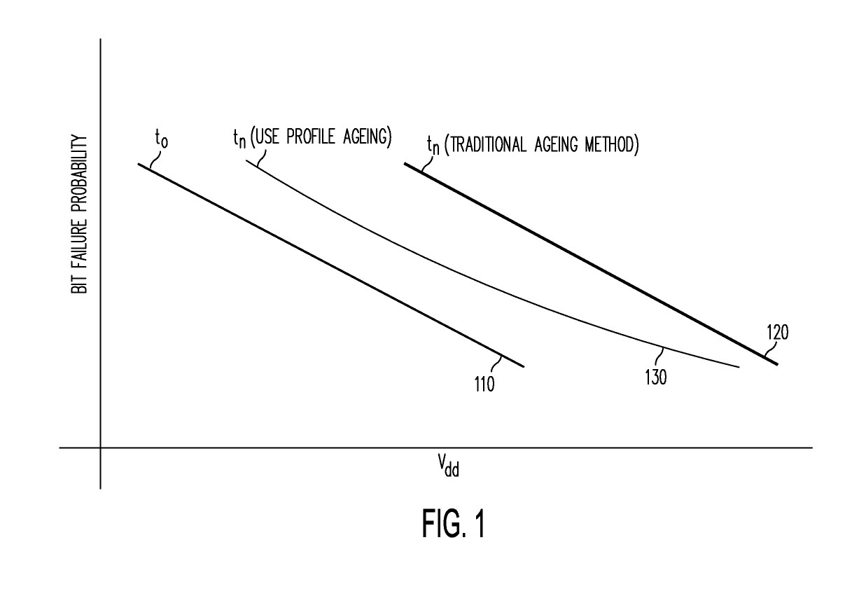

FIG. 1 is a simplified graph illustrating one example of ageing induced shifting of bit failure probability over time, and consequently a shifting in Vₘᵢₙ over time. While BTI is a primary contributor to this ageing-induced shifting, HCI does have a minor effect in SoC memory arrays.

In order to properly analyze the lifetime performance of an SoC that incorporates a large number of transistors (e.g., in memory arrays), one must take into account ageing effects and how they impact various operational states of the device (e.g., read vs. write operation in a memory). Traditionally, semiconductor devices operated at a set operational voltage (V_{dd}). Ageing analysis was performed in light of that set operational voltage. But modern semiconductor devices can be expected to operate at more than one operational voltage. For example, processors can be designed to operate in a “normal” operational mode and an “overdrive” operational mode. An “overdrive” operational mode can include operating at a higher operational voltage than that used for “normal” operational mode.

Typical ageing analysis does not take into account changes in operational voltages, such as overdrive. Instead, a typical ageing analysis will use the highest operational voltage over the lifetime of the part to generate ageing information. But this results in an overly conservative result for ageing of the semiconductor device at any time in the lifetime of the device. This is because, typically, a semiconductor device spends only a fraction of the device lifetime at the high operational voltage, while the remainder is spent at the lower operational voltage. A time spent at the lower operational voltage will result in less ageing-related effects than the same amount of time spent at the higher operational voltage. Further, less time spent at the higher operational voltage over the life of the device will result in a significant difference in the amount of damage, as compared to analyzing the device at the higher operational voltage over the life of the device.

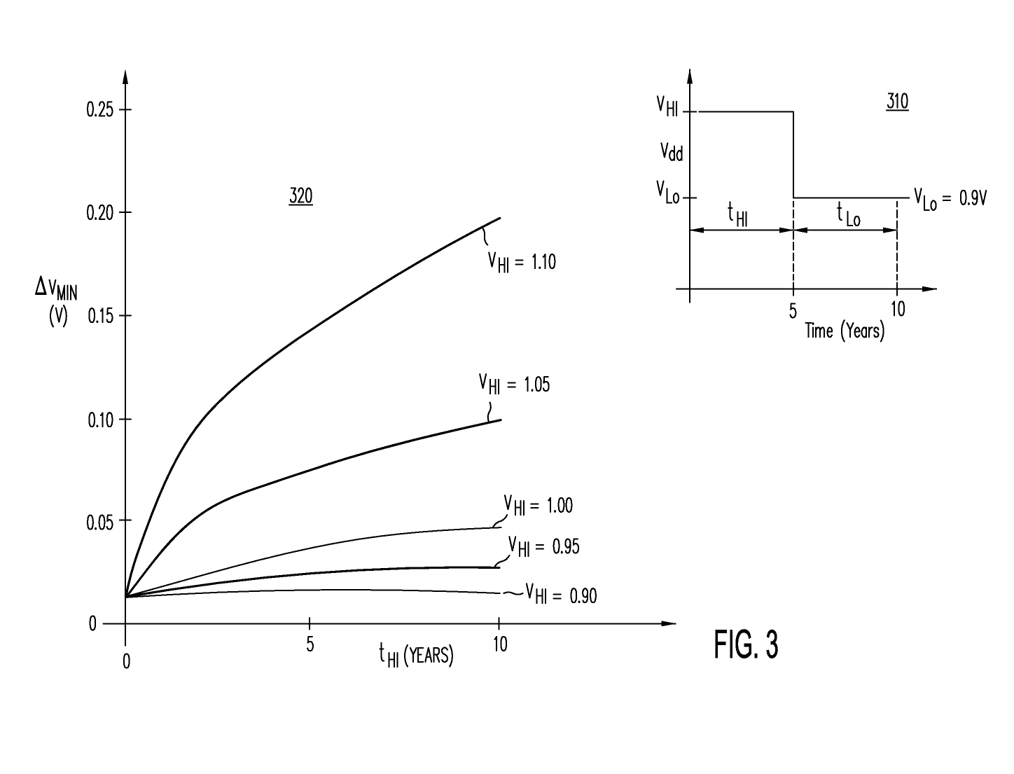

FIG. 3 is a chart illustrating an example of a shift in the minimum operational voltage (Vₘᵢₙ) in light of differing use profiles and differing high V_{dd} over the life of a part. Chart 310 illustrates an example use profile for the part. Over a ten year life span for the part, the device operates at both a high V_{dd} (V_{HI}) and a low V_{dd} (V_{LO}). The time spent at V_{HI} is t_{HI} and the time spent at V_{LO} is t_{LO}. For the sake of this discussion of FIG. 3, V_{LO} is fixed at 0.9 V, but any operational V_{LO} is within the bounds of embodiments of the present invention.

As illustrated in chart 320, the shift in Vₘᵢₙ is analyzed for several V_{HI} values ranging from, for example, 0.9 V to 1.1 V, while the time at V_{HI} ranges from zero to ten years. As illustrated, as V_{HI} increases, the Vₘᵢₙ shift increases over the spectrum of t_{HI} over the lifetime of the part. As is further illustrated, however, as t_{HI} decreases (i.e., the amount of time spent at V_{LO} increases), the amount of Vₘᵢₙ shift also decreases. This is indicative of less damage to the device over the life of the part, and a significant departure from the traditional conservative ageing analysis which only uses V_{HI} over the entire lifetime of the part (e.g., the value at t_{HI}=10 years). These effects are more pronounced for parts having a greater difference between “overdrive” voltage and “normal” voltage.

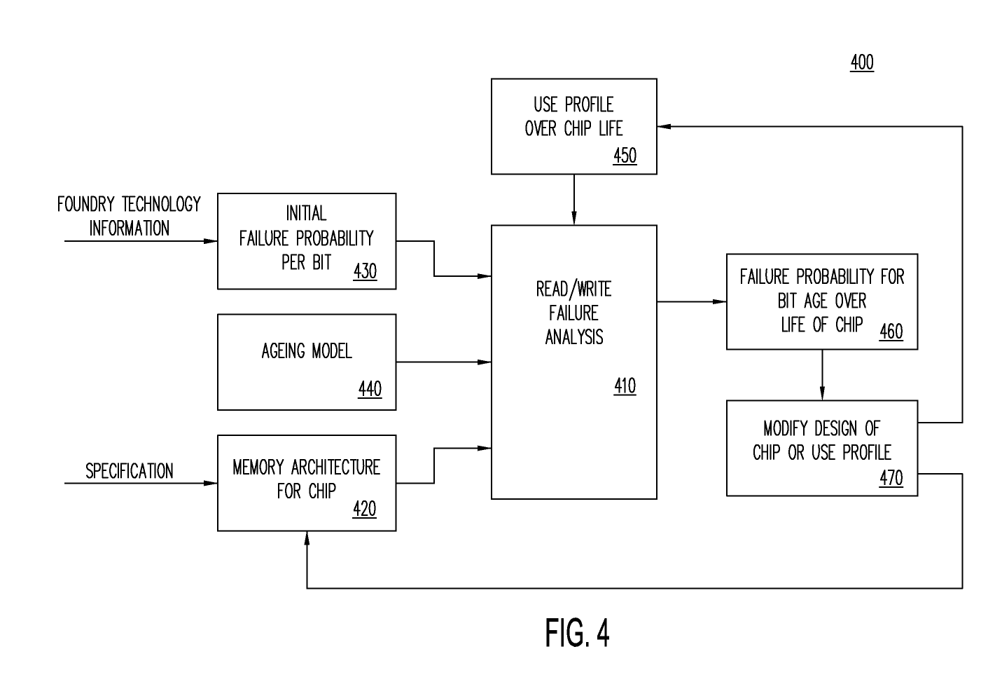

FIG. 4 is a simplified block diagram illustrating a system 400 for generating a failure probability for bit ageing over the lifetime of a chip that takes into account an operational use profile, in accord with embodiments of the present invention. System 400 provides a variety of inputs to a read/write failure analysis module 410 to generate the use profile-compensated failure probability for the design.

As discussed above, the design specification for the semiconductor device is used to generate a schematic of the semiconductor device. The schematic includes the memory architecture for the semiconductor device (420). The memory architecture can include the bitcells of the memory arrays, periphery logic associated with the memory arrays, the sizes of the memory arrays, the number of memory arrays in the device, and the like. The memory architecture information is provided to system 400 as a netlist, which can include a bill of materials (e.g., types of bitcells present, and number of bits of each type of bitcell), anticipated voltage ranges for the device, and critical path definitions (e.g., the minimal read and write circuit paths that allows the memory to operate).

The memory architecture information can be used to generate an initial failure probability curve per bit (430) for the device (for example, curve 110 in FIG. 1). This initial failure probability curve per bit can be generated from information provided by the foundry. This information includes the foundry's analysis of the memory architecture information, such as the types of bitcells, numbers of bits, and the other information discussed above. The t₀ curve generated from this information gives the initial performance profile for the device, without ageing effects. This is used as the starting point for the ageing calculations.

An ageing model (440) is also provided to read/write failure analysis module (410). This model can be provided by either the foundry or generated by those performing the analysis to take into account the ageing effects desired. As discussed above, the ageing effects can include PBTI, NBTI, and HCI, depending upon the application. Those ageing effects can incorporate not only operational voltages, but also temperature and physical parameters of the transistors themselves. If the operational parameters for the device include not only differing operational voltages, but also differing operational temperatures, it may be desirable to use an ageing model that incorporates temperature. Likewise, the model may not include a temperature use profile should the device be expected to operate at consistent temperatures over the device's lifetime.

In order to take into account lifetime operational usage profile, the read/write failure analysis module uses a predicted use profile over chip life (450). This use profile can include a time spent at differing operational voltages (e.g., t_{HI} and t_{LO}) as well as the values for those operational voltages (e.g., V_{HI} and V_{LO}). In addition, the use profile can include differing expected operational temperatures when the device being analyzed is at V_{HI} or V_{LO}, if the application and ageing model suggest inclusion of temperature values. If the ageing model requires inclusion of other operational values that may change over the lifetime of the device being analyzed, then the use profile over chip life can include those values as well.

In one embodiment, ageing calculations are cumulative and do not depend upon previous ageing damage. Thus, an operational voltage use profile need only provide time spent at differing operational voltages, and need not provide expected shifts in operational voltage at any particular time in the life of the device (e.g., chart 310). In other embodiments, ageing models may depend upon previous damage, and therefore the use profile may reflect the time periods that the device is at differing operational voltages over the lifetime of the device.

The read/write failure analysis module performs the ageing analysis for operational profiles of both read and write to the bits in the defined memory arrays of the memory architecture for the chip. As will be discussed more thoroughly below, read and write behavior due to ageing degradation over the life of the chip is different. Read is sensitive to the value of the minimum operational voltage (Vₘᵢₙ) and involves a linear sensitivity analysis. On the other hand write is sensitive not only to the operational voltage but also to the timing of the circuit, which tends to be a non-linear analysis of how quickly the write line voltage pulse rises and falls. Both take into account the critical path of the memory architecture (e.g., read path and write path), but write also takes into account pulse shapes.

As a result of this analysis, the read/write failure analysis module will generate two failure probability curves for the bit age over the life of the chip (460). One curve will reflect a failure probability for read operations and the other for write operations. Depending upon the nature of the memory array being analyzed (e.g., number of bits, configuration, and where damage is concentrated) and the use profile, the damage to the array may affect reads or writes more. In either case, however, it is expected that the bit failure probability curve will be less than that generated by typical ageing methods, which only use the highest V_{dd} for the ageing calculation.

As illustrated by curves 120 and 130 in FIG. 1, the bit failure probability curve that takes into account use profile (curve 130) shows a lower bit failure probability for a particular V_{dd} than does the traditional ageing model (curve 120), but still a higher bit failure probability than that at time 0 (curve 110). In addition, the bit failure at time tₙ probability curve 130 reflects the worst of read or write bit failure probability at the various V_{dd} values, and therefore departs from the more linear bit failure probability curves 110 and 120.

Once the failure probability for the bit age over the life of the chip is determined, it can then be determined whether changes to either the chip design or the use profile are needed in order to satisfy a desired bit failure probability at the end of life for the chip (470). For example, a determination can be made as to whether to use a different bitcell (e.g., a bitcell incorporating a transistors having differing channel lengths or widths) in order to arrive at a desired failure probability at time tn. Or alternatively, a different use profile in which the chip spends less time at a higher operational voltage may be indicated. The solution can fit the application for the semiconductor device. These changes can then be provided either to the memory architecture for the chip (420) or the use profile over chip life (450), and the calculations can be performed again. Once the chip satisfies the desired failure probability over the life of the chip, the design can be passed along to further stages in the design or manufacturing process.

FIG. 5 is a simplified flow diagram illustrating a process for providing a read/write failure analysis as executed by read/write failure analysis module 410. As an initial matter, the read/write failure analysis receives a netlist for the memory architecture (510) and a foundry model for the initial failure probability calculation of that memory architecture (520). As discussed above, the memory architecture for the device being analyzed is determined by the schematics for the device. A netlist can be generated from the schematic, where the netlist includes, for example, a bill of materials of the memory arrays found on the chip, the number of bits of each type found in the memory arrays, and critical signal paths for the memory arrays and bits in the memory arrays. The foundry model for the initial failure probability is typically provided by the foundry that will be fabricating the semiconductor device. The foundry model is dependent upon the types of bitcells/transistors found in the device as well as the foundry's own fabrication techniques.

From the memory architecture netlist and the foundry model, an initial (t₀) bit failure probability curve set for reads and writes on the memory arrays is generated (530). This initial curve set is used as the starting point for the ageing calculations over the life of the device. The failure probability is a failure of a bitcell to read or write within an operational amount of time. The time t₀ failure probability is a failure probability snapshot at the time the device is new.

As discussed above, the read and write failure probability calculations are performed differently due to the differing sensitivities of reads and writes. A read failure probability is primarily a linear relationship to V_{dd}. For every V_{dd} of interest, a sensitivity analysis of the read critical path is performed to approximate a linear pass/fail boundary. On the other hand, a write failure is not a linear relationship because the write margin is expressed as a write line overlap past time to write metric. Therefore, in one embodiment, an interpolated fit to V_{dd} increases is performed, instead of an assumption of constant sensitivities (as in the read analysis). A simplified netlist of the critical path is used to create a lookup table for the interpolation in order to reduce computation. Write also takes into account pulse shapes for the write, which are approximated in one embodiment using a piecewise linear approximation, again to simplify computation.

Once the t₀ failure probability is calculated for reads and writes, a use profile for the life of the device is received (540). As discussed above, the use profile can take a variety of forms depending upon the ageing model used for the memory architecture, which is retrieved from a storage in one embodiment (550). In some ageing models, damage due to ageing is a cumulative effect that can be approximated by providing a time that the device is at each operational voltage. In other ageing models, damage due to ageing can be dependent upon previous damage, and therefore the use profile will be specific to when in the life of the device the various operational voltages are applied.

Using the initial failure probability curve, the use profile, and the ageing model, a time n (tₙ) failure probability curve is generated for reads and writes (560). Time n is contemplated as end of designed use life, but can be any time over the age of the device. As with the t₀ calculation, the tₙ calculation includes both a read failure probability calculation and a write failure probability calculation. The read failure probability calculation is performed as a sensitivity analysis, again because of the approximately linear pass/fail boundary for each V_{dd}. The write failure probability calculation is performed as an interpolation, as described above. The ageing is provided by introducing new shift variables for Vₘᵢₙ according to assumptions related to both BTI and HCI (if used). A bitfail probability integration is performed that includes the initial plus Vmin shift variables to produce a final aged bitfail margin across V_{dd}.

Once a tₙ failure probability curve is generated, a determination can be made as to whether the device at tₙ satisfies desired design parameters (570). That is, whether the device's operational voltages have shifted beyond the expected operational envelope for the device. If the device satisfies the design parameters at tₙ, then the design/fabrication process can proceed (580). If the device does not satisfy the design parameters at tₙ, then a decision can be made to modify the design of the device (e.g., change the type of bitcell used, or other facets of the memory architecture) or alter the expected use profile (e.g., reduce the amount of time spent at V_{HI}) (590). Once the modifications have been decided upon, the read/write failure analysis can be performed again to determine whether the modified design or use profile results in a device satisfying the design parameters.

By now it should be appreciated that there has been provided a semiconductor device design system that includes a schematic editor configured to generate a schematic for a semiconductor device where the schematic comprises a memory architecture for the semiconductor device, and an electronic design automation system configured to receive the schematic from the schematic editor and determine a future time failure probability for the memory architecture using a use profile between an initial time and the future time and an ageing model for the memory architecture.

In one aspect of the above embodiment the electronic design automation system is further configured to determine whether the future time failure probability for the memory architecture conforms to a design specification for the semiconductor device at that future time, and modify one or more of the schematic or the use profile in response to a determination that the future time failure probability for the memory architecture does not conform to the design specification.

In another aspect of the above embodiment, the electronic design automation system is further configured to determine an initial time failure probability for the memory architecture, and use the initial time failure probability for the memory architecture to perform said determining the future time failure probability for the memory architecture. In a further aspect, the electronic design automation system is further configured to determine the initial time failure probability for the memory architecture using information associated with the memory architecture provided by a foundry used to fabricate the semiconductor device.

In another aspect of the above embodiment, the electronic design automation system is configured to determine the future time failure probability for the memory architecture by being further configured to determine a future time read failure probability over a range of operational voltages, and determine a future time write failure probability over the range of operational voltages. In a further aspect, the electronic design automation system is configured to determine the future time read failure probability by being further configured to perform a sensitivity analysis to approximate a linear pass/fail boundary for each operational voltage. In another aspect, the electronic design automation system is configured to determine the future time write failure probability by being further configured to interpolate over a minimum operation voltage space for the semiconductor device.

In another aspect of the above embodiment, the electronic design automation system is further configured to generate a netlist from the schematic, where the netlist includes identification of the memory arrays included in the semiconductor device, a number of bits of each type found in the memory arrays, definitions of critical paths for the bits in the memory arrays and the memory arrays, and a definition of peripheral circuitry in the critical paths for the memory arrays.

Another embodiment of the present invention provides a method for determining a failure probability of a semiconductor device. The method includes: generating a schematic for the semiconductor device including a memory architecture; converting the schematic to a netlist for the semiconductor device; and, determining a future time failure probability of the memory architecture using the netlist, a supply voltage use profile between an initial time and the future time, and an ageing model for the memory architecture.

One aspect of the above embodiment further includes determining whether the future time failure probability for the memory architecture conforms to a predetermined design specification for the semiconductor device at that future time. A further aspect includes modifying one or more of the schematic or the use profile in response to a determination that the future time failure probability for the memory architecture does not conform to the design specification.

Another aspect of the above embodiment further includes determining an initial time failure probability for the memory architecture, and using the initial time failure probability for the memory architecture as an initial condition for determining the future time failure probability for the memory architecture. A further aspect includes using information associated with the memory architecture provided by a foundry used to fabricate the semiconductor device to determine the initial time failure probability for the memory architecture.

In another aspect of the above embodiment, determining the future time failure probability for the memory architecture further includes determining a future time read failure probability over a range of operational voltages, and determining a future time write failure probability over the range of operational voltages. In a further aspect, determining the future time failure probability for the memory architecture further includes setting a future time failure probability for an operational voltage within the range of operational voltages as the highest of the future time read failure probability and the future time write failure probability for that operational voltage. In another further aspect, determining the future time read failure probability includes performing a sensitivity analysis to approximate a linear pass/fail boundary for each operational voltage. In another further aspect, determining the future time write failure probability further includes interpolating over a minimum operational voltage space for the semiconductor device.

The term “program,” as used herein, is defined as a sequence of instructions designed for execution on a computer system. A program, or computer program, may include a subroutine, a function, a procedure, an object method, an object implementation, an executable application, an applet, a servlet, a source code, an object code, a shared library/dynamic load library and/or other sequence of instructions designed for execution on a computer system.

Some of the above embodiments, as applicable, may be implemented using a variety of different information processing systems. For example, although FIG. 2 and the discussion thereof describe an exemplary design architecture, this exemplary architecture is presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

All or some of the software described herein may be received elements of design system 200, for example, from computer readable media. Such computer readable media may be permanently, removably or remotely coupled to a design system such as system 200. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, and the like.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A semiconductor device design system comprising:
a schematic editor configured to generate a schematic for a semiconductor device, wherein the schematic comprises a memory architecture for the semiconductor device; and
an electronic design automation system configured to
receive the schematic from the schematic editor, and
determine a future time failure probability for the memory architecture using a use profile between an initial time and a future time and an ageing model for the memory architecture.

2. The semiconductor device design system of claim 1 wherein the electronic design automation system is further configured to
determine whether the future time failure probability for the memory architecture conforms to a design specification for the semiconductor device at that future time; and
modify one or more of the schematic or the use profile in response to a determination that the future time failure probability for the memory architecture does not conform to the design specification.

3. The semiconductor device design system of claim 1 wherein the electronic design automation system is further configured to
determine an initial time failure probability for the memory architecture; and
use the initial time failure probability for the memory architecture to perform said determining the future time failure probability for the memory architecture.

4. The semiconductor device design system of claim 3 wherein the electronic design automation system is further configured to
perform said determining the initial time failure probability for the memory architecture using information associated with the memory architecture provided by a foundry used to fabricate the semiconductor device.

5. The semiconductor device design system of claim 1 wherein the electronic design automation system is configured to perform said determining the future time failure probability for the memory architecture by being further configured to
determine a future time read failure probability over a range of operational voltages; and
determine a future time write failure probability over the range of operational voltages.

6. The semiconductor device design system of claim 5 wherein the electronic design automation system is configured to perform said determining the future time read failure probability by being further configured to perform a sensitivity analysis to approximate a linear pass/fail boundary for each operational voltage.

7. The semiconductor device design system of claim 5 wherein the electronic design automation system is configured to perform said determining the future time write failure probability by being further configured to interpolate over a minimum operation voltage space for the semiconductor device.

8. The semiconductor device design system of claim 1 wherein the electronic design automation system is further configured to
generate a netlist from the schematic, wherein the netlist comprises identification of the memory arrays included in the semiconductor device, a number of bits of each type found in the memory arrays, definitions of critical paths for the bits in the memory arrays and the memory arrays, and a definition of peripheral circuitry in the critical paths for the memory arrays.

9. The semiconductor device design system of claim 1 wherein the use profile comprises one or more of a supply voltage use profile and a device temperature use profile.

10. A method for determining a failure probability of a semiconductor device, the method comprising:
generating a schematic for the semiconductor device comprising a memory architecture;
converting the schematic to a netlist for the semiconductor device;
determining a future time failure probability of the memory architecture using the netlist, a use profile between an initial time and a future time, and an ageing model for the memory architecture.

11. The method of claim 10 further comprising:
determining whether the future time failure probability for the memory architecture conforms to a predetermined design specification for the semiconductor device at that future time.

12. The method of claim 11 further comprising:
modifying one or more of the schematic or the use profile in response to a determination that the future time failure probability for the memory architecture does not conform to the design specification.

13. The method of claim 10 further comprising:
determining an initial time failure probability for the memory architecture; and
using the initial time failure probability for the memory architecture as an initial condition for determining the future time failure probability for the memory architecture.

14. The method of claim 13 further comprising:
using information associated with the memory architecture provided by a foundry used to fabricate the semiconductor device to perform said determining the initial time failure probability for the memory architecture.

15. The method of claim 10 wherein performing said determining the future time failure probability for the memory architecture further comprises:
determining a future time read failure probability over a range of operational voltages; and
determining a future time write failure probability over the range of operational voltages.

16. The method of claim 15 wherein performing said determining the future time failure probability for the memory architecture further comprises:
setting a future time failure probability for an operational voltage within the range of operational voltages as the highest of the future time read failure probability and the future time write failure probability for that operational voltage.

17. The method of claim 15 wherein performing said determining the future time read failure probability comprises:
performing a sensitivity analysis to approximate a linear pass/fail boundary for each operational voltage.

18. The method of claim 15 wherein performing said determining the future time write failure probability further comprises:
interpolating over a minimum operational voltage space for the semiconductor device.

19. The method of claim 10 wherein the use profile comprises one or more of a supply voltage use profile and a temperature use profile.
